(19) United States
(12) Patent Application Publication
(10) Pub. No.: US 2016/0228882 A1
(43) Pub. Date: Aug. 11, 2016

(54) NEGATIVE IONIZER AIR PURIFIER

(71) Applicant: SHENZHEN TONGSHENG GREEN TECHNOLOGY CO.,LTD, Shenzhen, Guangdong (CN)

(72) Inventors: Yu-shiang LIN, Shenzhen, Guangdong (CN); Fujun SUN, Shenzhen, Guangdong (CN)

(73) Assignee: Shenzhen China Star Optoelectronics Technology Co. , Ltd., Shenzhen, Guangdong (CN)

(21) Appl. No.: 15/021,683

(22) PCT Filed: Nov. 12, 2013
(86) PCT No.: PCT/CN2013/086925

§ 371 Date: Mar. 11, 2016

(30) Foreign Application Priority Data
Sep. 16, 2013 (CN) 201310423193.7

(51) Int. Cl. B03C 3/66; B03C 3/41; B03C 3/38

(52) U.S. Cl. CPC B03C 3/66; B03C 3/38; B03C 3/41

(57) ABSTRACT

A negative ionizer air purifier is provided. It includes a power adapter, a high-voltage generator and discharge terminals. A first input terminal of the power adapter connects to the live wire of the AC mains, a second input terminal connects to the naught wire, and the third input terminal connects to the earth wire. The power adapter converts an AC voltage inputted through its first and second input terminals to a low DC voltage and outputs it to the high-voltage generator, which further boosts the low DC voltage to a high DC voltage and outputs it. The first output terminal of the high-voltage generator connects to the discharge terminals, and the second output terminal connects to a reference earth and also to the third input terminal of the power adapter, where the reference earth refers to the housing of the negative air purifier.

### FIELD OF THE DISCLOSURE

The present disclosure relates to air purification, and more particularly, to a negative ionizer air purifier.

### BACKGROUND OF THE DISCLOSURE

With the continuous development of global industrialization, the urban environmental pollution is becoming increasingly serious. Air purification is now becoming an important issue in today's world faced with the serious situation of air pollution. Currently there is a wide variety of air purifiers, which typically include high-efficiency particulate arrestance (HEPA), activated carbon filtration, low-temperature plasma, photocatalysis, negative ions or anions, etc. Typically, an anion refers to an oxygen ion which gains one or more extra electrons and thus has a net negative charge. Anions can bind with bacteria and dust and kill the bacteria, before they are attracted and settled down to the earth, such that the bacteria and dust can be removed.

Referring, to FIG. 1, a circuit diagram of a prior art negative ionizer air purifier is shown. The negative ionizer air purifier 10 includes a power adapter 11, a high-voltage generator 12, discharge terminals 13 and a positive electrode plate 14. One terminal of the power adapter Ii may connect to the live wire L of the alternating current (AC) mains, while the other terminal may connect to the naught wire N. The power adapter 11 may convert an AC voltage input into a low direct current (DC) voltage, such as a low DC voltage of 12 volts (V). The high-voltage generator 12 may further boost the low DC voltage outputted from the power adapter 11 to a high

DC voltage, such as a high DC voltage of 6000V. The positive electrode plate 14 is connected to a second terminal of the high-voltage generator 12. The discharge terminals 13 are connected to a first terminal of the high-voltage generator 12, and may release electrons outward when a high DC voltage is applied. In the above negative ionizer air purifier 10, since a virtual earth is applied to the positive electrode plate 14, an excess of positive charge may accumulate on the positive electrode plate 14 when the discharge terminals 13 release electrons outward, due to charge balance. Thus, when the negative ionizer air purifier 10 has been working for some time, the positive electrode plate 14 may be saturated with positive charge, which may lower the speed of releasing electrons by the discharge terminals 13, resulting in a substantial decline in the efficiency of the negative ionizer air purifier 10.

The prior art negative ionizer air purifier also has the following shortcomings.

The air near the front of the discharge terminals 13 is static in absence of external forces. Due to the poor airflow, the electrons released from the discharge terminals 13 cannot be effectively captured by the air beyond a very limited range, which may also reduce the efficiency of the negative ionizer air purifier.

In addition, the discharge terminals 13 are encased inside the housing, and the electrons released by the discharge terminals 13 may decomposite a portion of the carbon dioxide in the atmosphere into carbon, which may attach to the interior of the housing and thus may be very difficult to clean. Since carbon has a certain electrical conductivity and the housing between two discharge terminals 13 is continuous, a short circuit is prone to occur between them.

Furthermore, the prior art negative ionizer air purifiers rely solely on the discharge terminals 13 to release electrons, the concentration of the electrons is relatively low, such that the concentration of the anions produced is very limited, which may also accounts for the low efficiency of the negative ionizer air purifiers.

### SUMMARY OF THE DISCLOSURE

A technical issue to be addressed by the disclosure is to provide a negative ionizer air purifier, in which a second output terminal of the high-voltage generator will not be saturated with positive charge, such that the efficiency of releasing electrons can be improved and the efficiency of the negative ionizer air purifier can be significantly increased.

To address the above technical issue, a negative ionizer air purifier is provided and it includes a power adapter, a high-voltage generator and discharge terminals. The power adapter includes a first input terminal, a second input terminal and a third input terminal. The high-voltage generator includes a first output terminal and a second output terminal. The first input terminal of the power adapter may connect to the live wire of the alternating current (AC) mains, the second input terminal ma connect to the naught wire of the AC mains, and the third input terminal may connect to the earth wire of the AC mains. The power adapter may convert an AC voltage inputted through its first and second input terminals into a low direct current (DC) voltage and output it to the high-voltage generator, which may further boost the low DC voltage to a high DC voltage and output it. The first output terminal of the high-voltage generator may connect to the discharge terminals, and the second output terminal may connect to a reference earth and also to the third input terminal of the power adapter, where the reference earth refers to the housing of the negative ionizer air purifier, Each discharge terminal may include a discharge fiber bundle, and there may be at least two such discharge terminals. The negative ionizer air purifier may further include a housing, in which may be defined with at least two receiving holes, and each discharge terminal is disposed through the corresponding receiving hole. The housing may be hollowed out at the part between the discharge terminals.

The power adapter may be provided with a first connector, and the high-voltage generator may be provided with a second connector, which can mate with the first connector in order to transfer a low DC voltage to the high-voltage generator. One terminal of the first connector may connect to a third input terminal of the power adapter, and one terminal of the second connector may connect to a second output terminal of the high-voltage generator, and the said terminal of the first connector will be connected electrically to the said terminal of the second connector when the first connector mates with the second connector.

The number of the high-voltage generators is not smaller than two, and the first output terminal of each high-voltage generator may independently connect to at least one discharge terminal.

The hollows may include arc-shaped hollows.

The high-voltage generator may be disposed inside the housing.

The negative ionizer air purifier may further include a fan disposed inside the housing. The housing may be provided with airflow passages through which the airflow produced by the fan can drive the air near the discharge terminals to move.

The number of the airflow passages may be the same as that of the discharge terminals. The airflow passages may be provided below the respective discharge terminals, and the air outlets of the airflow passages may directly face the centers of the respective discharge terminals.

To address the above technical issue, a negative ionizer air purifier is further provided and it includes a power adapter, a high-voltage generator and discharge terminals. The power adapter includes a first input terminal, a second input terminal and a third input terminal. The high-voltage generator includes a first output terminal and a second output terminal. The first input terminal of the power adapter may connect to the live wire of the alternating current (AC) mains, the second input terminal may connect to the naught wire of the AC mains, and the third input terminal may connect to the earth wire of the AC mains. The power adapter may convert an AC voltage inputted through its first and second input terminals into a low direct current (DC) voltage and output it to the high-voltage generator, which may further boost the low DC voltage to a high DC voltage and output it. The first output terminal of the high-voltage generator may connect to the discharge terminals, and the second output terminal may connect to a reference earth and also to the third input terminal of the power adapter, where the reference earth refers to the housing of the negative ionizer air purifier.

Each discharge terminal may include a discharge fiber bundle.

The power adapter may be provided with a first connector, and the high-voltage generator may be provided with a second connector, which can mate with the first connector in order to transfer the low DC voltage to the high-voltage generator. One terminal of the first connector may connect to a third input terminal of the power adapter, and one terminal of the second connector may connect to the second output terminal of the high-voltage generator, thus the said terminal of the first connector will be connected electrically to the said terminal of the second connector when the first connector mates with the second connector.

The number of the high-voltage generators is not smaller than two, and the first output terminal of each high-voltage generator may be independently connected to at least one discharge terminal

There may be at least two discharge terminals. The negative ionizer air purifier may further include a housing, in which may be defined with at least two receiving holes, and each discharge terminal is disposed through the corresponding receiving hole. The housing may be hollowed out at the part between the discharge terminals.

The hollows may include arc-shaped hollows.

The high-voltage generator may be disposed inside the housing.

The negative ionizer air purifier may further include a fan disposed inside the housing. The housing may be provided with airflow passages through which the airflow produced by the fan can drive the air near the discharge terminals to move.

The number of the airflow passages may be the same as that of the discharge terminals. The airflow passages may be provided below the respective discharge terminals, and the air outlets of the airflow passages may directly face the centers of the respective discharge terminals.

Advantages of the present disclosure may follow: by connecting the second output terminal of the high-voltage generator to the earth wire of the power adapter, the second output terminal is in effect connected to an actual earth and thus won't be saturated with an excess of positive charge, such that the efficiency of releasing electrons can be significantly improved.

### BRIEF DESCRIPTION OF THE DRAWINGS

FIG. 1. is a circuit diagram of a prior art negative ionizer air purifier.

FIG. 2 is a circuit diagram of a first example negative ionizer air purifier according to the present disclosure.

FIG. 3 is a circuit diagram of a second example negative ionizer air purifier according to the present disclosure.

FIG. 4 is a circuit diagram of a third example negative ionizer air purifier according to the present disclosure.

FIG. 5 is a circuit diagram of a fourth example negative ionizer air purifier according to the present disclosure.

FIG. 6 shows a schematic diagram of a fifth example negative ionizer air purifier according to the present disclosure.

FIG. 7 shows a schematic diagram of a sixth example negative ionizer air purifier according to the present disclosure.

FIG. 8 shows a schematic diagram of a seventh example negative ionizer air purifier according to the present disclosure.

FIG. 9 shows a schematic diagram of a base of the seventh example negative ionizer air purifier according to the present disclosure.

FIG. 10 shows a schematic diagram of an eighth example negative ionizer air purifier according to the present disclosure.

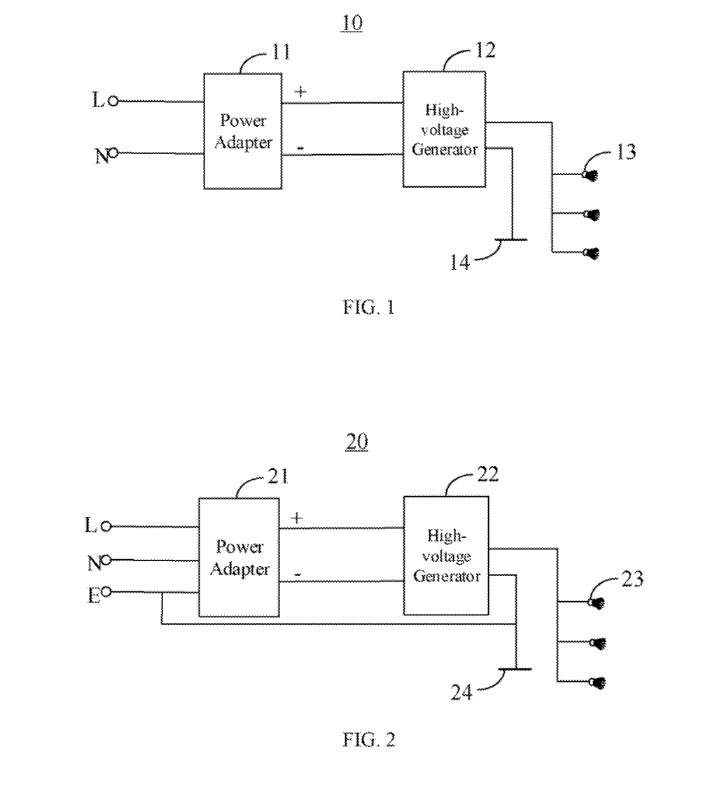

### DETAILED DESCRIPTION OF THE DISCLOSURE

Referring to FIG. 2, a circuit diagram of a first example negative ionizer air purifier according to the disclosure is shown. The negative ionizer air purifier 20 includes a power adapter 21, a high-voltage generator 22, discharge terminals 23 and a positive electrode plate 24. Each discharge terminal 23 may include a discharge fiber bundle. The power adapter 21 may include a first input terminal, a second input terminal and a third input terminal. The high-voltage generator 22 may include a first output terminal and a second output terminal. The first input terminal of the power adapter 21 may connect to the live wire L of the alternating current (AC) mains, the second input terminal may connect to the naught wire N of the AC mains, and the third input terminal may connect to the earth wire E of the AC mains. The power adapter 21 may convert an AC voltage (e.g., an AC voltage of 220 volts (V)), which is inputted through the first and second input terminals, into a low direct current (DC) voltage (e.g., a low DC voltage of 12V), and output the low DC voltage to the high-voltage generator 22.

The high-voltage generator 22 may further boost the low DC voltage outputted from the power adapter 21 to a high DC voltage e.g., a high DC voltage of 6000V) and output it. The first output terminal of the high-voltage generator 22 may connect to the discharge terminals, while the second output terminal may connect to a reference earth via the positive electrode plate 24. The reference earth may be the housing of the negative ionizer air purifier, and the positive electrode plate 24 may be in contact with the housing of the negative ionizer air purifier, which thus is becoming a virtual earth. Thus, the discharge terminals 23 may release electrons outwards when the high DC voltage is applied. The connecting wire between the first output terminal of the high-voltage generator 22 and the discharge terminals 23 may be a high-voltage cable. There may be at least one discharge terminal 23, for example, there are three discharge terminals 23 in the current embodiment. However, the number of the discharge terminals 23 is not limited to three, and can be, for example, one, two, six, etc. The positive electrode plate 24 can be a conductor of any shape, typically a metal ring.

The second output terminal of the high-voltage generator 22 may further connect electrically to the third input terminal of the power adapter 21 and thus be electrically connected to the earth wire E of the AC mains. Thus, the virtual earth, to which the second output terminal of the prior art high-voltage generator 22 connects, can be changed to an actual earth, through which the positive charge, accumulating on the second output terminal of the high-voltage generator 22 during the working process of the negative ionizer air purifier 20, can be conducted away, and the problem that the speed of releasing electrons by the discharge terminals 23 slows down due to the possible positive charge saturation on the second output terminal can be addressed, which can effectively improve the efficiency of releasing electrons by the discharge terminals 23.

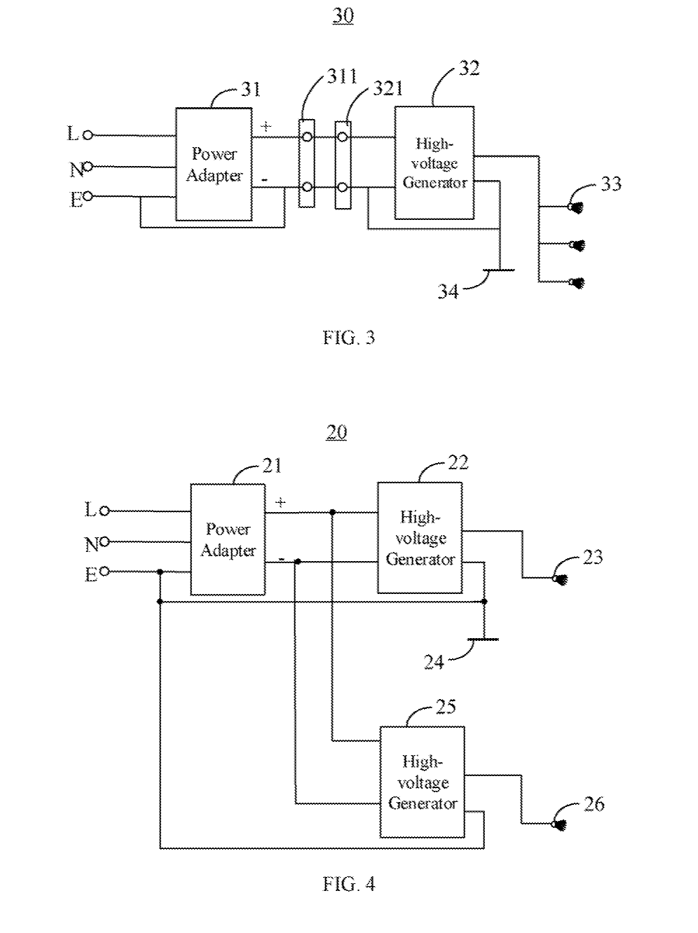

Referring now to FIG. 3, a circuit diagram of a second example negative ionizer air purifier according to the disclosure is shown. The negative ionizer air purifier 30 includes a power adapter 31, a high-voltage generator 32, discharge terminals 33 and a positive electrode plate 34. The first input terminal of the power adapter 31 may connect to the live wire L of the AC mains, the second input terminal may connect to the naught wire N of the AC mains, and the third input terminal may connect to the earth wire E of the AC mains. There may be at least two high-voltage generators in the current embodiment, and a first output terminal of each high-voltage generator is independently connected to at least one discharge terminal. The negative ionizer air purifier 30 according to the current embodiment differs from the first example negative ionizer air purifier 20 in that, the power adapter 31 is provided with a first connector 311, while the high-voltage generator 32 is provided with a second connector 321, which can mate with the first connector 311 to achieve the electrical connection between the power adapter 31 and the high-voltage generator 32 and thus to further transfer the low DC voltage outputted from the power adapter 31 to the high-voltage generator 32. One terminal of the first connector 311 may connect electrically to the third input terminal of the power adapter 31, and one terminal of the second connector 321 may be connected to a reference earth via, the positive electrode plate 34. Thus, when the first connector 311 mates with the second connector 321, the said terminal of the first connector 311 will be connected electrically to the said terminal of the second connector 321, such that the positive electrode plate 34 can be electrically connected to the third input terminal (earth wire E) of the power adapter 31. in this case, the second output terminal of the high-voltage generator 32 is substantially connected to an actual earth and thus the efficiency of releasing electrons by the discharge terminals 33 can be improved.

The high-voltage generator and the discharge terminals can form more than one subsystem. Referring now to FIG. 4, a circuit diagram of a third example negative ionizer air purifier according to the disclosure is shown. Referring also to FIG. 2. The negative ionizer air purifier 20 includes a high-voltage generator 25 and a high-voltage generator 22, which are connected in parallel. A first output terminal of the high-voltage generator 25 may connect to the discharge terminal 26, while the second output terminal may connect to a reference earth via the positive electrode plate 24. To improve the efficiency of releasing electrons, the second output terminal of the high-voltage generator 25 may connect to the third input terminal of the power adapter 21 in order to connect to the earth wire E of the AC mains. The discharge terminal 23 may release electrons outwards when a high DC voltage is applied.

Typically, there would be a power loss at a high-voltage cable connected between a high-voltage generator and a discharge terminal The power loss can be calculated by the equation P=U²/R, where P refers to the power loss of the high-voltage cable, U refers to the voltage drop across the high-voltage cable, and R refers to the resistance of the high-voltage cable. As can be concluded, the longer the high-voltage cable, the larger the resistance R and the larger the voltage drop, and thus the larger the power loss because of the extremely high voltage on the high-voltage cable, in which case the efficiency of the negative ionizer air purifier of releasing electrons would be drastically lowered. in the negative ionizer air purifier as shown in FIG. 2, the high-voltage generator 22 is connected to multiple discharge terminals 23, which would inevitably require a comparatively long high-voltage cable to connect to the discharge terminals 23 that are relatively far away from the high-voltage generator 22, resulting in a low efficiency of releasing electrons and a low power utilization factor of these discharge terminals 23 In contrast, the negative ionizer air purifier, as shown in FIG. 4, uses a design of at least two high-voltage generators 22 and 25, either connected to only one discharge terminal 23 or 26. Thus, the total length of the high-voltage cables can be minimized, and thus a minimum power loss and a maximum power utilization factor can be achieved.

In addition, if one high-voltage generator is connected to multiple discharge terminals, the following problems may occur.

1) The high-voltage generator may easily burn out. To meet the power requirements of multiple discharge terminals, a high-voltage generator with high power would be required. However, it is not straightforward and practical to find in the market a high-voltage generator whose rated power is exactly equal to the total power of the designed number of discharge terminals. Thus, the manufacturers are forced to use the high-voltage generator whose rated power is even larger than the total power of the multiple discharge terminals, if, during the working process of the high-power high-voltage generator, the anions in the air surrounding the discharge terminals reach the saturation point, then the electrons cannot be emitted but will accumulate in the high-voltage generator and produce heat, in which case the internal components or circuits would be burnt out when the heat accumulates to a certain extent Hence, even when a single discharge terminal cannot release more electrons due to anion-saturation or restricted air circulation because of fan breakdown, the high-power high voltage generator will be vulnerable to burn out. Whereas, according to the current embodiment, two high-voltage generators 22 and 25 are used each connected to only one discharge terminal 23 or 26. Thus, it is much easier to find a high-voltage generator with a smaller and suitable rated power. In addition, the usage of at least two high-voltage generators with a relatively low rated power can in effect achieve an equivalent efficiency of releasing electrons with a single high-power high-voltage generator. Furthermore, since the rated power is comparatively low, the internal components or circuits won't burn out even when the electrons are not well released.

2) It is difficult to find the suitable high-voltage generator, and thus will increase the design and manufacture difficulty and the cost In the case only one high-voltage generator is used in the negative ionizer air purifier, typically a high-voltage generator with a comparatively high rated power would be required, and the required rated power may also vary because the number of discharge terminals applied may vary, which thus will increase the difficulty of obtaining the suitable high-voltage generator, the difficulty of design and manufacture, and also the cost.

Whereas in the current embodiment, two high-voltage generators 22 and 25 are used each connected to only one discharge terminal 23 or 26. Thus, it is much easier to find a high-voltage generator with a smaller and suitable rated power, and different power requirements can also be satisfied by the addition and subtraction of the number of the same category high-voltage generators, which can significantly reduce the difficulty of design and manufacture and the cost. For example, in order to design a 1.2 watts (W) negative ionizer air purifier, a combination of four 0.3 W high-voltage generators can be used. While in order to design a 1.5 W negative ionizer air purifier, a combination of five 0.3 W high-voltage generators can be used. In contrast, if a single high-power high-voltage generator is employed, the high-voltage generator with power of 1.2 W or 1.5 W needs be respectively designed.

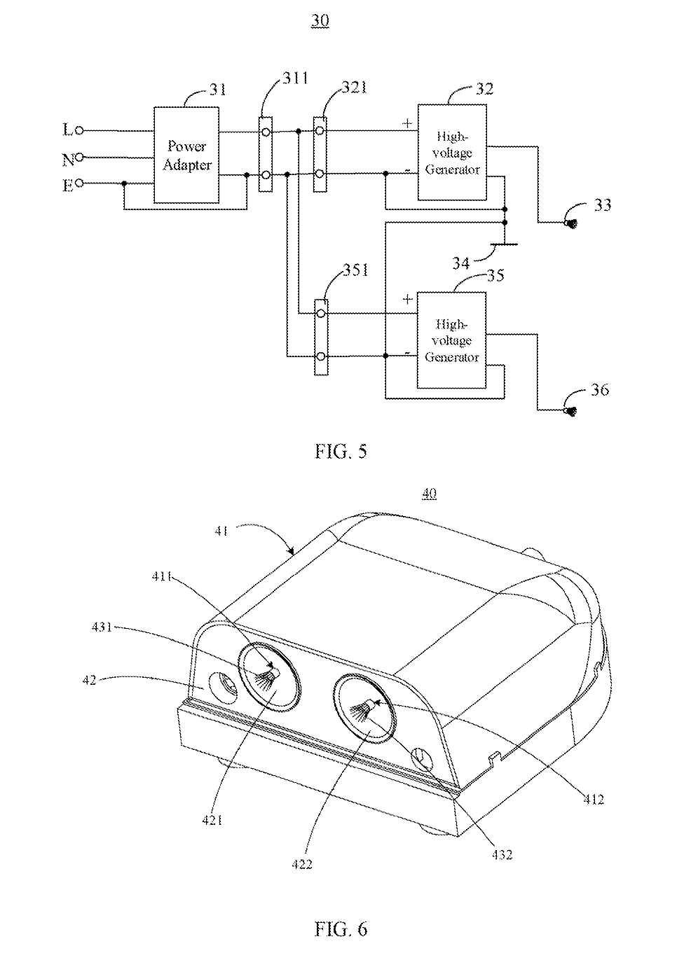

Referring now to FIG. 5, a circuit diagram of a fourth example negative ionizer air purifier according to the. disclosure is shown. Referring also to FIG. 3. The negative ionizer air purifier 30 includes a high-voltage generator 35 and a to high-voltage generator 32, which are connected in parallel. The first output terminal of the high-voltage generator 35 may connect to the discharge terminal 36, while the second output terminal may connect to the positive electrode plate 34. The high-voltage generator 35 may be provided with a third connector 351, which can mate with the first connector 311 in order to achieve the electrical connection between the power adapter 31 and the high-voltage generator 35 and thus to further transfer the low DC voltage outputted from the power adapter 31 to the high-voltage generator 35. One terminal of the third connector 351 may be connected to the reference earth via the positive electrode plate 34. Thus, when the first connector 311 mates with the third connector 351, the said terminal of the first connector 311 will be connected electrically to the said terminal of the third connector 351, such that the positive electrode plate 34 can be electrically connected to the third input terminal (earth wire E) of the power adapter 31. In this case, the positive electrode plate 34 can be substantially connected to the actual earth and thus the efficiency of releasing electrons by the discharge terminal 36 can be improved. In the negative ionizer air purifier as shown in FIG. 5, either of the high-voltage generators 35 and 32 is connected to only one discharge terminal 33 or 36. Thus, the total length of the high-voltage cables can be minimized, such that the power loss of the high-voltage cables can be minimized and the high voltage generators will not easily burn out. In addition, the requirements for design techniques can be reduced, and so does the complexity of the production preparation.

Referring now to FIG. 6, a schematic diagram of a fifth example negative ionizer air purifier according to the disclosure is shown. The negative ionizer air purifier 40 includes a housing 41. The high-voltage generators and positive electrode plate mentioned in the above embodiments may be disposed inside the housing 41. While the power adapter can be disposed inside the housing 41, or it can be disposed outside the housing 41 and electrically connect to the high-voltage generator(s) inside the housing 41 by plug-in.

The housing 41 may be provided with receiving holes 411 and 412, and discharge terminals 431 and 432 may be disposed in the respective receiving holes 411 and 412, and protrude from the exterior of the housing 41 More specifically, the housing 41 may include a fiat front panel 42, in which two circular recesses 421 and 422 may be defined. The receiving hole 411 or 412 may be defined respectively in the center of the corresponding recess 421 or 422 The discharge terminals 431 and 432 may be respectively placed in the corresponding receiving holes 411 and 412 and protrude from the exterior of the recesses 421 and 422. The receiving holes 411 and 412 can be of any shape, typically circular. In the current embodiment, there are two discharge terminals 431 and 432 and two receiving holes 411 and 412, however, there may be any number, typically larger than 2, of discharge terminals and receiving holes.

The discharge terminals 431 and 432 may easily absorb dust and the carbon produced from the decomposition of carbon dioxide in the surrounding air, which may reduce the efficiency of the negative ionizer air purifier. By configuring the discharge terminals 431 and 432 to protrude from the exterior of the housing 41, it will be convenient to clean the discharge terminals periodically. More to the point, the carbon produced from the decomposition of carbon dioxide would attach to the front panel 42, thus the user needs not clean the interior of the housing which is hard to reach, such that it would be very convenient for the user to do cleaning and maintenance for the negative ionizer air purifier.

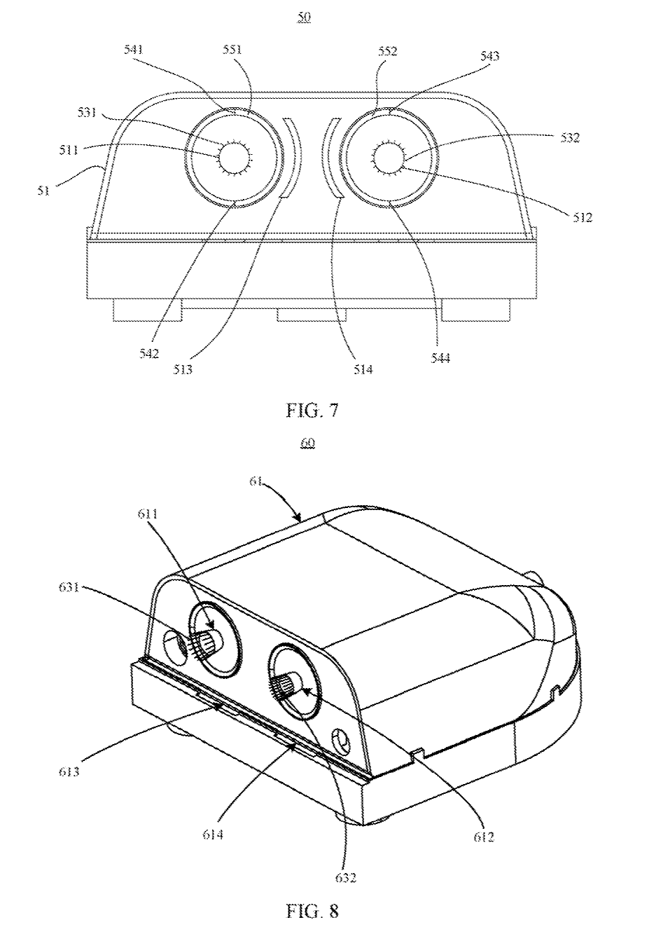

Referring now to FIG. 7, a schematic diagram of a sixth example negative ionizer air purifier according to the disclosure is shown. The negative ionizer air purifier 50 includes a housing 51. The housing 51 may be provided with receiving holes 511 and 512, and discharge terminals 531 and 532 may be disposed in the respective receiving holes 511 and 511 The negative ionizer air purifier 50 according to the current embodiment differs from the third example negative ionizer air purifier 40 shown in FIG. 4 in that, the housing 51 is further hollowed out at the periphery of either discharge terminal and at the part between the discharge terminals 531 and 532. The hollows may include annular hollows 551 and 552 and arc-shaped hollows 513 and 514. More specifically, the annular hollows 551 and 552 may be provided at the respective peripheries of the discharge terminals 531 and 532, namely the discharge terminals 531 and 532 are located respectively within the annular hollows 551 and 552. Either of the annular hollows 551 and 552 may be comprised of two substantial semi-annular hollows. The contact part connecting the ends of the two substantial semi-annular hollows is a portion of the housing 51. The area of the contact part should be as small as possible, and typically the width of the contact part is set to be 2 mm. Of course, either of the two annular hollows 551 and 552 can be a full-annular hollow, namely the outer boundary and inner boundary of either of the annular hollows 551 and 552 are completely separated by air. The arc-shaped hollows 513 and 514 may be concentrically defined with the discharge terminals 531 and 532, respectively. The widths of the arc-shaped hollows 513 and 514 are typically larger than 2 mm. The central angles of the arc-shaped hollows 513 and 514 are typically larger than 30 degrees, and the arc lengths of the arc-shaped hollows 513 and 514 are larger than the respective diameters of the receiving holes. The widths and central angles of the arc-shaped hollows 513 and 514 are not limited to 2 mm and 30 degrees, and can also be. any other values. For example, the widths can be 1 mm, 3 mm or any other suitable value which can enable the separation by air.

Similarly., the central angles can be 20 degrees, 40 degrees, or any other value which can enable the separation by air. It should be appreciated that those of skill in the art can think, of hollows of other shapes to be defined in the housing 51, based on actual requirements. The above hollows can also be applied to other embodiments where the discharge terminals 531 and 532 do not protrude from the exterior of the housing

In the negative ionizer air purifiers in which at least two high-voltage generators are used, there may be a certain potential difference between two discharge terminals. Without the hollow design of the disclosure, the carbon, produced from the decomposition of the carbon dioxide in the surrounding air due to the electrons emitted from the discharge terminals 531 and 532, will attach to the surface of the housing 51 and thus may cause a short circuit between the two discharge terminals 531 and 532. By defining the annular hollows 551 and 552 at the respective peripheries of the discharge terminals and the arc-shaped hollows 513 and 514 between the discharge terminals, the discharge terminals 531 and 532 can be electrically separated effectively, thus the short circuit between the discharge terminals 531 and 532 that is caused by the carbon, produced from the decomposition of carbon dioxide and attached to the surface of the housing, can be avoided.

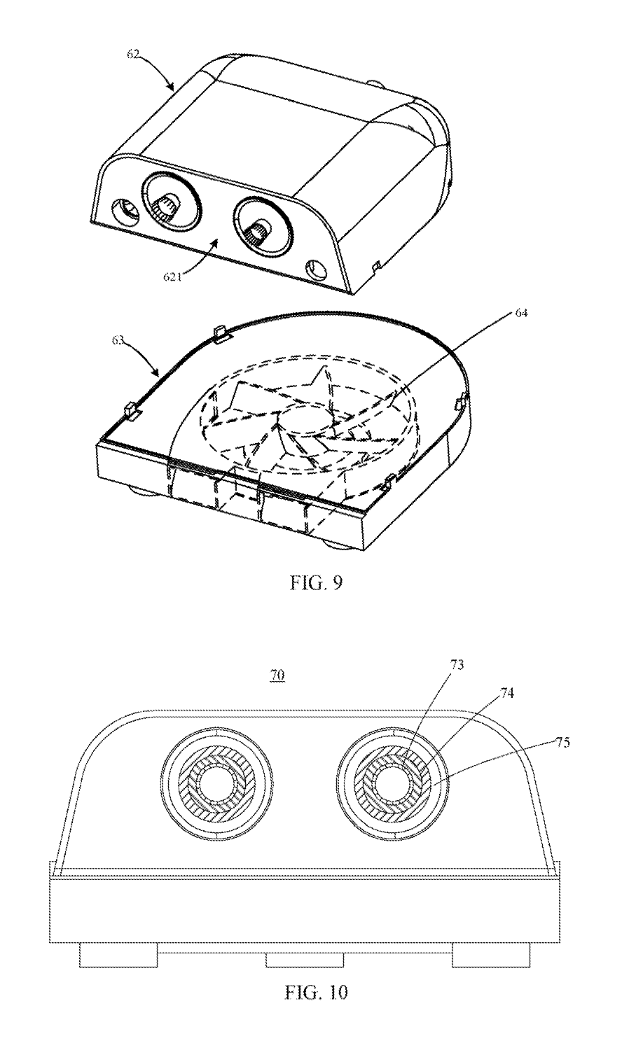

Referring now to FIGS. 8-9, where FIG. 8 is a schematic diagram of a seventh example negative ionizer air purifier according to the disclosure, FIG. 9 is a schematic diagram of a base of the seventh example negative ionizer air purifier. The negative ionizer air purifier 60 includes a housing 61. The housing 61 may be provided with receiving holes 611 and 612, and discharge terminals 631 and 632 may be respectively disposed through the receiving holes 611 and 612. In addition, the negative ionizer air purifier 60 may further include a fan 64 disposed inside the housing 61. The housing 61 may be provided with independent airflow passages 613 and 614, such that the airflow produced by the fan 64 may flow respectively through the passages 613 and 614 and drive the air near the discharge terminals 631 and 632 to move. More specifically, the housing 61 may include an upper housing 62 and a base 63, which are detachably disposed. The upper housing 62 may be supported on the base 63 when they are working. The receiving holes 611 and 612 may be defined in the upper housing 62, specifically, in the flat front panel 621 of the upper housing 62. The upper housing 62 may further define a first accommodation space, and the high-voltage generators, the positive electrode plate and the power adapter mentioned above can be disposed in the first accommodation space. The airflow passages 613 and 614 may be provided on the base 63, which may further define a second accommodation space, in which the fan 64 may be set. The base 63 may further be provided with baffle mechanisms to limit the airflow produced by the fan 64, so as to change the direction of the airflow such that it can flow out through the passages 613 and 614.

In the current embodiment, the number of the airflow passages 613 and 614 is the same as that of the discharge terminals 631 and 632. Either of the discharge terminals is directly below the corresponding discharge terminal 631 or 632, such that the air outlets of the passages 613 and 614 will directly face the centers of the discharge terminals 631 and 632, respectively. However, the number of the passages may not be the same as that of the discharge terminals, and the specific positions of the passages can be set based on actual requirements. The speed of the airflow produced by the fan is adjustable The greater the voltage at the discharge terminals 631 and 632, the more the total electrons released from the discharge terminals, and the higher the concentration of the anions in the surrounding air. Meanwhile, when the voltage at the discharge terminals 631 and 632 is constant, the larger the number of the discharge terminals, the more the total electrons released from the discharge terminals, and the higher the concentration of the anions in the surrounding air. However, when the concentration of the anions in the surrounding air reaches its saturation point, it will no longer increase. hi this case, by increasing the speed of the airflow produced by the fan 64, the concentration of the anions in the surrounding air of the discharge terminals 631 and 632 can be decreased. Hence in one embodiment, the speed of the airflow produced by the fan 64 is larger than the speed of the saturated anions being produced in the surrounding air (in other words, the saturation speed).

Thus, the speed of the airflow surrounding the discharge terminals 631 and 632 can be accelerated, such that more air, which is not negatively charged, can fill in the working area in the vicinity of the discharge terminals 631 and 632, and the surrounding air that is already negatively charged can be driven away as quickly as possible, thus the efficiency of the negative ionizer air purifier can be significantly improved. In the prior art, however, the air in the vicinity of the discharge terminals cannot be easily replaced, in which case however high the voltage at the discharge terminals is or however large the number of the discharge terminals is, the anion-generation efficiency will not be increased too much when the ionization of the air within the working area reaches its saturation point-since the air is not replaced in time and the working area of multiple discharge terminals may at least partly overlap. Thus, it would lose the meaning of increasing the number of the discharge terminals and the voltage or power at the discharge terminals. With the airflow-driven approach according to the disclosure, the effects of increasing the number and voltage of the discharge terminals can be truly reflected. In addition, the inventor(s) of the disclosure found in at least one embodiment that the anion-generation efficiency has little to do with the magnitude of power, but has much to do with the voltage at the discharge terminals. Thus, in at least one embodiment, by increasing the voltage at the discharge terminals and combining the airflow-driven approach, the anion-generation efficiency can be significantly improved.

Referring now to FIG. 10, a schematic diagram of an eighth example negative ionizer air purifier according to the disclosure is shown. The negative ionizer air purifier 70 is provided with two energy rings at the periphery of the discharge terminal 73. The two energy rings are typically concentric with the discharge terminal 73. The inner ring is an electron-enhancement ring 74, and the outer ring is an electron-control ring 75. The electron-enhancement ring 74 can release electrons outward when a changing electric field is produced by the discharge terminal 73. Specifically, the electron-enhancement ring 74 is of a suitable piezoelectric ceramic material which may create a tendency of volume expansion, due to piezoelectric effect, within the changing electric field produced by the discharge terminal 73. Whereas the outer electron-control ring 75 is of a non-piezoelectric material, whose shape will not be affected by the electric field. Thus, the outer electron-control ring 75 can prevent the volume expansion of the electron-enhancement ring 74. Hence, the electron-enhancement ring 74 will release electrons under a combination of the pressure from the electron-control ring 75 and the high electric field. The high electric field may be produced by the voltage fluctuation at the discharge terminal 73, and can also be produced by the pulse voltage at the discharge terminal 73. Since energy rings are further added in addition to the discharge terminals, they can take full advantage of the high electric field produced by the discharge terminals to release electrons. Therefore, the anion concentration can be increased and the efficiency of the negative ionizer air purifier 70 can be further improved.

In the embodiments described above, a negative ionizer air purifier enabled based on any two or more embodiments shall all be covered within the protection scope of the present disclosure.

In conclusion, advantages of the present disclosure may follow: by connecting the second output terminal of the high-voltage generator to the earth wire of the power adapter, the second output terminal is in effect connected to an actual earth and thus won't be saturated with an excess of positive charge, such that the efficiency of releasing electrons can be significantly improved.

The above description is merely the embodiments of the disclosure, but is not limiting the scope of the disclosure. Any equivalent structures or flow transformations made to the disclosure, or any direct or indirect applications of the disclosure on other relevant fields, shall all be covered within the protection of the disclosure.

1. A negative ionizer air purifier comprising a power adapter, a high-voltage generator, discharge terminals and a housing, wherein the power adapter comprises a first input terminal, a second input terminal and a third input terminal, and the high-voltage generator comprises a first output terminal and a second output terminal, wherein the first input terminal of the power adapter connects to a live wire of the alternating current (AC) mains, the second input terminal connects to a naught wire of the AC mains, and the third input terminal connects to an earth wire of the AC mains, wherein the power adapter converts an AC voltage inputted through its first and second input terminals to a low direct current (DC) voltage and outputs it to the high-voltage generator, which further boosts the low DC voltage to a high-DC voltage and outputs it, wherein the first output terminal of the high-voltage generator connects to the discharge terminals, and the second output terminal connects to a reference earth and also to the third input terminal of the power adapter, where the reference earth is the housing of the negative ionizer air purifier;
wherein each discharge terminal comprises a discharge fiber bundle, and there are at least two such discharge terminals, and the housing is defined with at least two receiving holes corresponding to the discharge terminals each disposed through the corresponding receiving hole, and the housing is provided with hollows between the discharge terminals.

2. The negative ionizer air purifier according to claim 1, wherein the power adapter is provided with a first connector and the high-voltage generator is provided with a second connector, which mates with the first connector in order to transfer the low direct current voltage to the high-voltage generator, wherein one terminal of the first connector connects electrically to a third input terminal of the power adapter, and one terminal of the second connector connects electrically to the second output terminal of the high-voltage generator, and the said terminal of the first connector is connected electrically to the said terminal of the second connector when the first connector mates with the second connector.

3. The negative ionizer air purifier according to claim 2, wherein there are at least two such high-voltage generators, and the first output terminal of each high-voltage generator is independently connected to at least one of the discharge terminals.

4. The negative ionizer air purifier according to claim 1, wherein the hollows comprise arc-shaped hollows.

5. The negative ionizer air purifier according to claim 1, wherein the high-voltage generator is disposed inside the housing.

6. The negative ionizer air purifier according to claim 1, further comprising a fan disposed inside the housing, in which is provided with airflow passages through which airflow produced by the fan drives the air near the discharge terminals to move.

7. The negative ionizer air purifier according to claim 6, wherein the number of the airflow passages is the same as that of the discharge terminals, wherein the airflow passages are independently provided below the respective discharge terminals, and air outlets of the airflow passages directly face the respective centers of the discharge terminals.

8. A negative ionizer air purifier comprising a power adapter, a high-voltage generator, discharge terminals and a housing, wherein the power adapter comprises a first input terminal, a second input terminal and a third input terminal, and the high-voltage generator comprises a first output terminal and a second output terminal, wherein the first input terminal of the power adapter connects to a live wire of the alternating current (AC) mains, the second input terminal connects to a naught wire of the AC mains, and the third input terminal connects to an earth wire of the AC mains, wherein the power adapter converts an AC voltage inputted through its first and second input terminals to a low direct current (DC) voltage and outputs it to the high-voltage generator, which further boosts the low DC voltage to a high-DC voltage and outputs it, wherein the first output terminal of the high-voltage generator connects to the discharge terminals, and the second output terminal connects to a reference earth and also to the third input terminal of the power adapter, where the reference earth is the housing of the negative ionizer air purifier.

9. The negative ionizer air purifier according to claim 8, wherein each discharge terminal comprises a discharge fiber bundle.

10. The negative ionizer air purifier according to claim 8, wherein the power adapter is provided with a first connector and the high-voltage generator is provided with a second connector, which mates with the first connector in order to transfer the low DC voltage to the high-voltage generator, wherein one terminal of the first connector connects electrically to the third input terminal of the power adapter, and one terminal of the second connector connects electrically to the second output terminal of the high-voltage generator, and the said terminal of the first connector is connected electrically to the said terminal of the second connector when the first connector mates with the second connector.

11. The negative ionizer air purifier according to claim 10, wherein there are at least two such high-voltage generators, and the first output terminal of each high-voltage generator is independently connected to at least one of the discharge terminals.

12. The negative ionizer air purifier according to claim 8, wherein there are at least two such discharge terminals, and the negative ionizer air purifier further comprises a housing, in which is defined with at least two receiving holes, wherein each discharge terminal is disposed through the corresponding receiving hole, and the housing is provided with hollows at the part between the discharge terminals.

13. The negative ionizer air purifier according to claim 12, wherein the hollows comprise arc-shaped hollows.

14. The negative ionizer air purifier according to claim 12, wherein the high-voltage generator is disposed inside the housing.

15. The negative ionizer air purifier according to claim 12, further comprising a fan disposed inside the housing, in which is provided with airflow passages through which airflow produced by the fan drives the air near the discharge terminals to move.

16. The negative ionizer air purifier according to claim 15, wherein the number of the airflow passages is the same as that of the discharge terminals, wherein the airflow passages are independently provided below the respective discharge terminals, and air outlets of the airflow passages directly face the respective centers of the discharge terminals.

17. The negative ionizer air purifier according to claim 12, wherein the housing is further provided with annular hollows at the respective peripheries of the discharge terminals.

18. The negative ionizer air purifier according to claim 13, wherein the arc-shaped hollows are formed concentrically with the respective receiving holes.

19. The negative ionizer air purifier according to claim 12, further comprising an electron-enhancement ring disposed at the periphery of each discharge terminal, wherein the electron-enhancement ring releases electrons when a changing electric field is produced by the corresponding discharge terminal.

20. The negative ionizer air purifier according to claim 19, wherein the electron-enhancement ring is of a piezoelectric ceramic material, and creates a tendency of volume expansion when the changing electric field is applied.
